(19) United States
(12) Patent Application Publication
(10) Pub. No.: US 2019/0236603 A1
(43) Pub. Date: Aug. 1, 2019

(54) System, Method, and Computer Program Product for Automatically Providing a Merchant Account for a Merchant

(71) Applicant: Visa International Service Association, San Francisco, CA (US)

(72) Inventors: John Willard Rutledge, Madison, WI (US); Akshay Chopra, San Francisco, CA (US); Milind Sanghavi, Singapore (SG)

(21) Appl. No.: 16/265,035

(22) Filed: Feb. 1, 2019

Related U.S. Application Data
(60) Provisional application No. 62/624,993, filed on Feb. 1, 2018.

(51) Int. Cl. G06Q 20/40; G06Q 20/12; G06K 9/46

(52) U.S. Cl. CPC G06Q 20/405; G06K 2209/01; G06K 9/46; G06Q 20/12

(57) ABSTRACT

A system, method, and computer program product for automatically providing a merchant account for a merchant. A method may include receiving merchant account provisioning data associated with provisioning a merchant account of a merchant, storing the merchant account provisioning data associated with provisioning the merchant account of the merchant in a secure data structure, validating the merchant account provisioning data associated with provisioning the merchant account of the merchant based on a set of merchant account validation rules, and provisioning the merchant account of the merchant based on validating the merchant account provisioning data.

### CROSS REFERENCE TO RELATED APPLICATION

This application claims the benefit of U.S. Provisional Application No. 62/624,993, filed Feb. 1, 2018, the entire disclosure of which is hereby incorporated by reference in its entirety.

### BACKGROUND

### 1. Field

Non-limiting embodiments or aspects relate generally to automatically providing a merchant account for a merchant and, in some embodiment or aspects, to a method, system, and computer program product for automatically providing a merchant account for a merchant based on merchant account provisioning data associated with the merchant.

### 2. Technical Considerations

A merchant account may be a type of bank account that allows a business (e.g., a company, a merchant, etc.) to accept a payment for goods and/or services associated with a transaction (e.g., a payment transaction, etc.) via the bank account. For example, a merchant may be a type of bank account that allows a merchant to accept a payment made with a debit card and/or a credit card. In some instances, a merchant account may be established under an agreement (e.g., a merchant agreement, etc.) between a business (e.g., an acceptor, etc.) and a bank (e.g., an acquirer, a merchant acquiring bank, etc.) for the settlement of payment transactions involving portable financial devices (e.g., credit cards, debit cards, etc.). In some instances, a payment processor, independent sales organization (ISO), and/or a member service provider (MSP) may also be a party to the agreement.

In some examples, an acquirer may provide a merchant account for a merchant based on receiving information associated with the merchant from the merchant. The information associated with the merchant may include a number of documents (e.g., a business license, transaction records, etc.) that includes information associated with the merchant. The acquirer may provide the merchant account based on determining that the information associated with the merchant satisfies requirements for provisioning a merchant account (e.g., requirements for provisioning a merchant account associated with the acquirer, legal requirements for provisioning a merchant account, etc.). However, determining whether the information associated with the merchant satisfies the requirements for provisioning a merchant account may involve a relatively large amount of resources of the acquirer. In addition, there may be inconsistent requirements for provisioning a merchant account, which may increase time and processing resources involved in determining whether the information associated with the merchant satisfies requirements for provisioning a merchant account for the merchant.

### SUMMARY

Accordingly, provided are improved systems, devices, products, apparatuses, and/or methods for automatically providing a merchant account for a merchant.

According to some non-limiting embodiments or aspects, provided is a method for automatically providing a merchant account for a merchant, comprising: receiving, by at least one processor, merchant account provisioning data associated with provisioning the merchant account of the merchant; storing, by at least one processor, the merchant account provisioning data associated with provisioning the merchant account of the merchant in a secure data structure; validating, by at least one processor, the merchant account provisioning data associated with provisioning the merchant account of the merchant based on a set of merchant account validation rules; and provisioning, by at least one processor, the merchant account of the merchant based on validating the merchant account provisioning data.

In some non-limiting embodiments or aspects, the method further comprises performing an image capture technique on an electronic image file to determine the merchant account provisioning data associated with provisioning the merchant account of the merchant.

In some non-limiting embodiments or aspects, storing the merchant account provisioning data comprises: storing the merchant account provisioning data associated with provisioning the merchant account of the merchant in the secure data structure based on performing an image capture technique on an electronic image file.

In some non-limiting embodiments or aspects, receiving the merchant account provisioning data comprises: receiving the merchant account provisioning data associated with provisioning the merchant account of the merchant based on scanning an electronic image file of a document associated with the merchant.

In some non-limiting embodiments or aspects, receiving the merchant account provisioning data comprises: receiving the merchant account provisioning data associated with provisioning the merchant account of the merchant via a mobile application stored on a user device associated with the merchant.

In some non-limiting embodiments or aspects, validating the merchant account provisioning data associated with provisioning the merchant account of the merchant based on a set of merchant account validation rules associated with a country in which an acquirer system is located.

In some non-limiting embodiments or aspects, the set of merchant account validation rules include at least one of the following: threshold merchant account risk requirements; threshold requirements associated with a threshold account balance; threshold requirements associated with a period of time in which a merchant may have conducted business; or any combination thereof.

According to some non-limiting embodiments or aspects, provided is a system for automatically providing a merchant account for a merchant, comprising: one or more processors programmed and/or configured to: receive merchant account provisioning data associated with provisioning the merchant account of the merchant; store the merchant account provisioning data associated with provisioning the merchant account of the merchant in a secure data structure; validate the merchant account provisioning data associated with provisioning the merchant account of the merchant based on a set of merchant account validation rules; and provision the merchant account of the merchant based on validating the merchant account provisioning data.

In some non-limiting embodiments or aspects, the one or more processors are further programmed and/or configured to: perform an image capture technique on an electronic image file to determine the merchant account provisioning data associated with provisioning the merchant account of the merchant.

In some non-limiting embodiments or aspects, the one or more processors store the merchant account provisioning data by: storing the merchant account provisioning data associated with provisioning the merchant account of the merchant in the secure data structure based on performing an image capture technique on an electronic image file.

In some non-limiting embodiments or aspects, the one or more processors receive the merchant account provisioning data by: receiving the merchant account provisioning data associated with provisioning the merchant account of the merchant based on scanning an electronic image file of a document associated with the merchant.

In some non-limiting embodiments or aspects, the one or more processors receive the merchant account provisioning data by: receiving the merchant account provisioning data associated with provisioning the merchant account of the merchant via a mobile application stored on a user device associated with the merchant.

In some non-limiting embodiments or aspects, the one or more processors validate the merchant account provisioning data associated with provisioning the merchant account of the merchant based on a set of merchant account validation rules associated with a country in which an acquirer system is located.

In some non-limiting embodiments or aspects, the set of merchant account validation rules include at least one of the following: threshold merchant account risk requirements; threshold requirements associated with a threshold account balance; threshold requirements associated with a period of time in which a merchant may have conducted business; or any combination thereof.

According to some non-limiting embodiments or aspects, a computer program product comprising at least one non-transitory computer-readable medium including program instructions that, when executed by at least one processor, cause the at least one processor to: receive merchant account provisioning data associated with provisioning the merchant account of the merchant; store the merchant account provisioning data associated with provisioning the merchant account of the merchant in a secure data structure; validate the merchant account provisioning data associated with provisioning the merchant account of the merchant based on a set of merchant account validation rules; and provision the merchant account of the merchant based on validating the merchant account provisioning data.

In some non-limiting embodiments or aspects, the one or more processors are further programmed and/or configured to: perform an image capture technique on an electronic image file to determine the merchant account provisioning data associated with provisioning the merchant account of the merchant.

In some non-limiting embodiments or aspects, the one or more processors store the merchant account provisioning data by: storing the merchant account provisioning data associated with provisioning the merchant account of the merchant in the secure data structure based on performing an image capture technique on an electronic image file.

In some non-limiting embodiments or aspects, the one or more processors receive the merchant account provisioning data by: receiving the merchant account provisioning data associated with provisioning the merchant account of the merchant based on scanning an electronic image file of a document associated with the merchant.

In some non-limiting embodiments or aspects, the one or more processors receive the merchant account provisioning data by: receiving the merchant account provisioning data associated with provisioning the merchant account of the merchant via a mobile application stored on a user device associated with the merchant.

In some non-limiting embodiments or aspects, the one or more processors validate the merchant account provisioning data associated with provisioning the merchant account of the merchant based on a set of merchant account validation rules associated with a country in which an acquirer system is located, and wherein the set of merchant account validation rules include at least one of the following: threshold merchant account risk requirements; threshold requirements associated with a threshold account balance; threshold requirements associated with a period of time in which a merchant may have conducted business; or any combination thereof.

Further non-limiting embodiments or aspects are set forth in the following numbered clauses:

Clause 1. A method for automatically providing a merchant account for a merchant, comprising: receiving, by at least one processor, merchant account provisioning data associated with provisioning the merchant account of the merchant; storing, by at least one processor, the merchant account provisioning data associated with provisioning the merchant account of the merchant in a secure data structure; validating, by at least one processor, the merchant account provisioning data associated with provisioning the merchant account of the merchant based on a set of merchant account validation rules; and provisioning, by at least one processor, the merchant account of the merchant based on validating the merchant account provisioning data.

Clause 2. The method of clause 1, further comprising: performing an image capture technique on an electronic image file to determine the merchant account provisioning data associated with provisioning the merchant account of the merchant.

Clause 3. The method of clauses 1 or 2, wherein storing the merchant account provisioning data comprises: storing the merchant account provisioning data associated with provisioning the merchant account of the merchant in the secure data structure based on performing an image capture technique on an electronic image file.

Clause 4. The method of any of clauses 1-3, wherein receiving the merchant account provisioning data comprises: receiving the merchant account provisioning data associated with provisioning the merchant account of the merchant based on scanning an electronic image file of a document associated with the merchant.

Clause 5. The method of any of clauses 1-4, wherein receiving the merchant account provisioning data comprises: receiving the merchant account provisioning data associated with provisioning the merchant account of the merchant via a mobile application stored on a user device associated with the merchant.

Clause 6. The method of any of clauses 1-5, wherein validating the merchant account provisioning data associated with provisioning the merchant account of the merchant based on a set of merchant account validation rules associated with a country in which an acquirer system is located.

Clause 7. The method of any of clauses 1-6, wherein the set of merchant account validation rules include at least one of the following: threshold merchant account risk requirements; threshold requirements associated with a threshold account balance; threshold requirements associated with a period of time in which a merchant may have conducted business; or any combination thereof.

Clause 8. A system for automatically providing a merchant account for a merchant, comprising: one or more processors programmed and/or configured to: receive merchant account provisioning data associated with provisioning the merchant account of the merchant; store the merchant account provisioning data associated with provisioning the merchant account of the merchant in a secure data structure; validate the merchant account provisioning data associated with provisioning the merchant account of the merchant based on a set of merchant account validation rules; and provision the merchant account of the merchant based on validating the merchant account provisioning data.

Clause 9. The system of clause 8, wherein the one or more processors are further programmed and/or configured to: perform an image capture technique on an electronic image file to determine the merchant account provisioning data associated with provisioning the merchant account of the merchant.

Clause 10. The system of clauses 8 or 9, wherein the one or more processors store the merchant account provisioning data by: storing the merchant account provisioning data associated with provisioning the merchant account of the merchant in the secure data structure based on performing an image capture technique on an electronic image file.

Clause 11. The system of any of clauses 8-10, wherein the one or more processors receive the merchant account provisioning data by: receiving the merchant account provisioning data associated with provisioning the merchant account of the merchant based on scanning an electronic image file of a document associated with the merchant.

Clause 12. The system of any of clauses 8-11, wherein the one or more processors receive the merchant account provisioning data by: receiving the merchant account provisioning data associated with provisioning the merchant account of the merchant via a mobile application stored on a user device associated with the merchant.

Clause 13. The system of any of clauses 8-12, wherein the one or more processors validate the merchant account provisioning data associated with provisioning the merchant account of the merchant based on a set of merchant account validation rules associated with a country in which an acquirer system is located.

Clause 14. The system of any of clauses 8-13, wherein the set of merchant account validation rules include at least one of the following: threshold merchant account risk requirements; threshold requirements associated with a threshold account balance; threshold requirements associated with a period of time in which a merchant may have conducted business; or any combination thereof.

Clause 15. A computer program product comprising at least one non-transitory computer-readable medium including program instructions that, when executed by at least one processor, cause the at least one processor to: receive merchant account provisioning data associated with provisioning the merchant account of the merchant; store the merchant account provisioning data associated with provisioning the merchant account of the merchant in a secure data structure; validate the merchant account provisioning data associated with provisioning the merchant account of the merchant based on a set of merchant account validation rules; and provision the merchant account of the merchant based on validating the merchant account provisioning data.

Clause 16. The computer program product of clause 15, wherein the one or more processors are further programmed and/or configured to: perform an image capture technique on an electronic image file to determine the merchant account provisioning data associated with provisioning the merchant account of the merchant.

Clause 17. The computer program product of clauses 15 or 16, wherein the one or more processors store the merchant account provisioning data by: storing the merchant account provisioning data associated with provisioning the merchant account of the merchant in the secure data structure based on performing an image capture technique on an electronic image file.

Clause 18. The computer program product of any of clauses 15-17, wherein the one or more processors receive the merchant account provisioning data by: receiving the merchant account provisioning data associated with provisioning the merchant account of the merchant based on scanning an electronic image file of a document associated with the merchant.

Clause 19. The computer program product of any of clauses 15-18, wherein the one or more processors receive the merchant account provisioning data by: receiving the merchant account provisioning data associated with provisioning the merchant account of the merchant via a mobile application stored on a user device associated with the merchant.

Clause 20. The computer program product of any of clauses 15-19, wherein the one or more processors validate the merchant account provisioning data associated with provisioning the merchant account of the merchant based on a set of merchant account validation rules associated with a country in which an acquirer system is located, and wherein the set of merchant account validation rules include at least one of the following: threshold merchant account risk requirements; threshold requirements associated with a threshold account balance; threshold requirements associated with a period of time in which a merchant may have conducted business; or any combination thereof.

### BRIEF DESCRIPTION OF THE DRAWINGS

FIG. 1 is a diagram of a non-limiting embodiment or aspect of an environment in which systems, devices, products, apparatuses, and/or methods, described herein, can be implemented;

FIG. 2 is a diagram of a non-limiting embodiment or aspect of components of one or more devices and/or one or more systems of FIG. 1;

FIG. 3 is a flowchart illustrating a non-limiting embodiment or aspect of a method for automatically providing a merchant account for a merchant; and

FIG. 4 is a diagram of an implementation of a non-limiting embodiment or aspect of a process disclosed herein.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. A computing device may be a mobile or portable computing device, a desktop computer, a server, and/or the like. Furthermore, the term “computer” may refer to any computing device that includes the necessary components to receive, process, and output data, and normally includes a display, a processor, a memory, an input device, and a network interface. The term “computing system” may include one or more computing devices or computers. The terms “application” or “application program interface” (API) refers to computer code or other data sorted on a computer-readable medium that may be executed by a processor to facilitate the interaction between software components, such as a client-side front-end and/or server-side back-end for receiving data from the client. The term “interface” refers to a generated display, such as one or more graphical user interfaces (GUIs) with which a user may interact, either directly or indirectly (e.g., through a keyboard, mouse, touchscreen, etc.). Further, multiple computers, e.g., servers, or other computerized devices, such as an autonomous vehicle including a vehicle computing system, directly or indirectly communicating in the network environment may constitute a “system” or a “computing system”.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing system executing one or more software applications. A transaction processing system may include one or more server computers with one or more processors and, in some non-limiting embodiments or aspects, may be operated by or on behalf of a transaction service provider.

As used herein, the term “account identifier” may include one or more primary account numbers (PAN), tokens, or other identifiers (e.g., a globally unique identifier (GUID), a universally unique identifier (UUID), etc.) associated with a customer account of a user (e.g., a customer, a consumer, a lendee, a lender, and/or the like). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a primary account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides products and/or services, or access to products and/or services, to customers based on a transaction, such as a payment transaction. The term “merchant” or “merchant system” may also refer to one or more computer systems operated by or on behalf of a merchant, such as a server computer executing one or more software applications. The term “point-of-sale (POS) system,” as used herein, may refer to one or more computers and/or peripheral devices used by a merchant to engage in payment transactions with customers, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (such as, a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the terms “peer-to-peer payment transfer service” and “peer-to-peer payment transfer application” refer to one or more electronic devices and/or software applications configured to initiate and/or conduct person-to-person (e.g., account-to-account, etc.) transfers of payments or funds. For example, a peer-to-peer payment transfer service may include mobile devices executing a peer-to-peer payment transfer application, and may further include server-side software and/or databases (e.g., a lendee database, a lender database, etc.) for maintaining and providing request data and transaction data to the mobile devices. The term “peer-to-peer payment transfer service provider” may include an entity that provides and/or maintains a peer-to-peer payment transfer service for customers, such as Visa Direct®, and/or other like peer-to-peer payment transfer services. In some non-limiting examples, a transaction service provider may be a peer-to-peer payment transfer service provider.

As used herein, the term “portable financial device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a mobile device executing an electronic wallet application, a personal digital assistant (PDA), a security card, an access card, a wireless terminal, and/or a transponder, as examples. The portable financial device may include a volatile or a non-volatile memory to store information, such as an account identifier and/or a name of the account holder.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). The acquirer may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

Non-limiting embodiments or aspects are directed to systems, methods, and computer program products for automatically providing a merchant account for a merchant. In some non-limiting embodiments or aspects, a method includes receiving merchant account provisioning data associated with provisioning a merchant account of a merchant, storing the merchant account provisioning data associated with provisioning the merchant account of the merchant in a secure data structure, validating the merchant account provisioning data associated with provisioning the merchant account of the merchant based on a set of merchant account validation rules, and provisioning the merchant account of the merchant based on validating the merchant account provisioning data. In this way, the amount of resources of the acquirer involved in determining whether the information associated with the merchant satisfies the requirements for provisioning a merchant account may be reduced. In addition, the requirements for provisioning a merchant account may be consistent, which may reduce the time and resources involved in determining whether the information associated with the merchant satisfies the requirements for provisioning a merchant account.

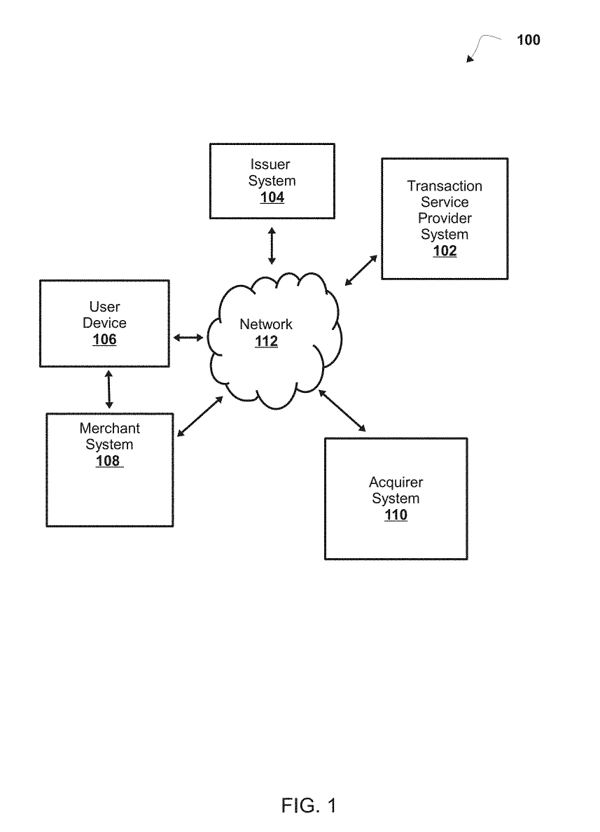

Referring now to FIG. 1, FIG. 1 is a diagram of an example environment 100 in which systems, devices, products, apparatuses, and/or methods, described herein, may be implemented. As shown in FIG. 1, environment 100 includes transaction service provider system 102, issuer system 104, user device 106, merchant system 108, acquirer system 110, and network 112.

Transaction service provider system 102 may include one or more devices capable of receiving information from and/or communicating information to issuer system 104, user device 106, merchant system 108, and/or acquirer system 110 via network 112. For example, transaction service provider system 102 may include a computing device, such as a server (e.g., a transaction processing server), a group of servers, and/or other like devices. In some non-limiting embodiments or aspects, transaction service provider system 102 may be associated with a transaction service provider as described herein. In some non-limiting embodiments or aspects, transaction service provider system 102 may be in communication with a data storage device, which may be local or remote to the transaction service provider system 102. In some non-limiting embodiments or aspects, transaction service provider system 102 may be capable of receiving information from, storing information in, communicating information to, or searching information stored in a data storage device.

Issuer system 104 may include one or more devices capable of receiving information and/or communicating information to transaction service provider system 102, user device 106, merchant system 108, and/or acquirer system 110 via network 112. For example, issuer system 104 may include a computing device, such as a server, a group of servers, and/or other like devices. In some non-limiting embodiments or aspects, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, merchant system 108, and/or acquirer system 110 via network 112. For example, user device 106 may include a client device and/or the like. In some non-limiting embodiments or aspects, user device 106 may or may not be capable of receiving information (e.g., from merchant system 108) via a short-range wireless communication connection (e.g., an NFC communication connection, an RFID communication connection, a Bluetooth® communication connection, and/or the like), and/or communicating information (e.g., to merchant system 108) via a short-range wireless communication connection.

Merchant system 108 may include one or more devices capable of receiving information from and/or communicating information to transaction service provider system 102, issuer system 104, user device 106, and/or acquirer system 110 via network 112. Merchant system 108 may also include a device capable of receiving information from user device 106 via network 112, a communication connection (e.g., an NFC communication connection, an RFID communication connection, a Bluetooth® communication connection, and/or the like) with user device 106, and/or the like, and/or communicating information to user device 106 via network 112, the communication connection, and/or the like. In some non-limiting embodiments or aspects, merchant system 108 may include a computing device, such as a server, a group of servers, a client device, a group of client devices, and/or other like devices. In some non-limiting embodiments aspects, merchant system 108 may be associated with a merchant as described herein. In some non-limiting embodiments or aspects, merchant system 108 may include one or more user devices 106. For example, merchant system 108 may include user device 106 that allows a merchant to communicate information to transaction service provider system 102. In some non-limiting embodiments or aspects, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or communicating information to transaction service provider system 102, issuer system 104, user device 106, and/or merchant system 108 via network 112. For example, acquirer system 110 may include a computing device, a server, a group of servers, and/or the like. In some non-limiting embodiments or aspects, acquirer system 110 may be associated with an acquirer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices and/or networks shown in FIG. 1 are provided as an example. There may be additional systems, devices and/or networks, fewer systems, devices and/or networks, different systems, devices and/or networks, or differently arranged systems, devices and/or networks than those shown in FIG. 1. Furthermore, two or more systems or devices shown in FIG. 1 may be implemented within a single device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of devices of environment 100.

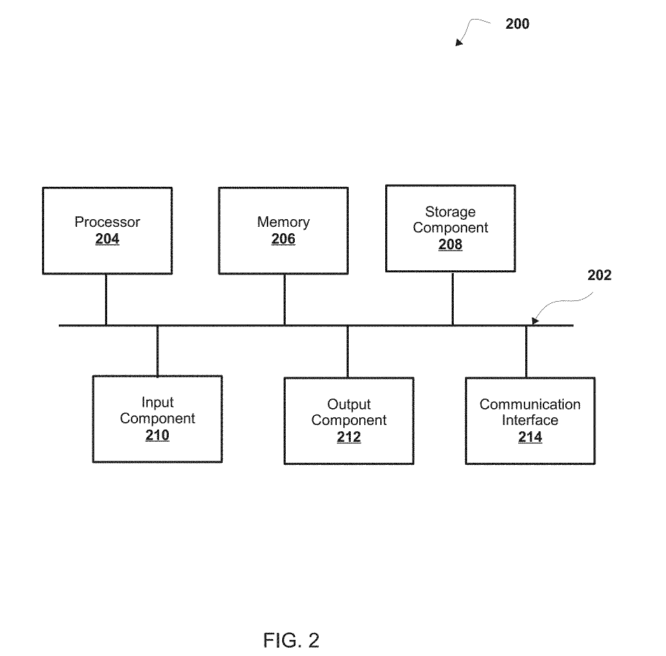

Referring now to FIG. 2, FIG. 2 is a diagram of example components of a device 200. Device 200 may correspond to one or more devices of transaction service provider system 102, and/or one or more devices of issuer system 104, user device 106, one or more devices of merchant system 108, and/or one or more devices of acquirer system 110. In some non-limiting embodiments or aspects, transaction service provider system 102, issuer system 104, user device 106, merchant system 108, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

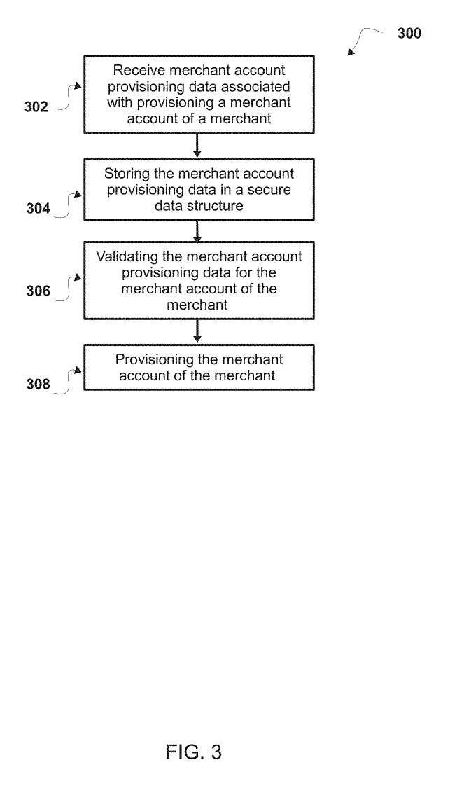

Referring now to FIG. 3, FIG. 3 is a flowchart of a non-limiting embodiment of a process 300 for automatically providing a merchant account for a merchant. In some non-limiting embodiments or aspects, one or more of the steps of process 300 may be performed (e.g., completely, partially, etc.) by acquirer system 110 (e.g., one or more devices of acquirer system 110). In some non-limiting embodiments or aspects, one or more of the steps of process 300 may be performed (e.g., completely, partially, etc.) by another device or a group of devices separate from or including acquirer system 110, such as transaction service provider system 102 (e.g., one or more devices of transaction service provider system 102), issuer system 104 (e.g., one or more devices of issuer system 104), user device 106, or merchant system 108 (e.g., one or more devices of merchant system 108).

As shown in FIG. 3, at step 302, process 300 includes receiving merchant account provisioning data associated with provisioning a merchant account of a merchant. For example, acquirer system 110 may receive merchant account provisioning data associated with provisioning a merchant account of a merchant. In some non-limiting embodiments or aspects, the embedding data may include data associated with a payment transaction.

In some non-limiting embodiments or aspects, the merchant account provisioning data may include data associated with an identification of a merchant associated with the merchant account and/or data associated with the merchant account (e.g., data associated with a type of the merchant account, data associated with capabilities of the merchant account, and/or the like). Additionally or alternatively, the merchant account provisioning data may include data associated with know your customer (KYC) requirements of an acquirer, data associated with goods and/or services offered by a merchant, data associated with an account balance of a merchant, data associated with payment transactions involving a merchant (e.g., data associated with past payment transactions involving a merchant, and/or the like), data associated with financial performance metrics associated with a merchant, data associated with a merchant account of the merchant, data associated with a number of locations (e.g., physical locations of a merchant, locations of a store of a merchant, and/or the like) of a merchant, and/or the like.

In some non-limiting embodiments or aspects, acquirer system 110 may receive merchant account provisioning data associated with provisioning the merchant account of the merchant from a merchant associated with the merchant account provisioning data. For example, acquirer system 110 may receive the merchant account provisioning data based on a merchant associated with the merchant account provisioning data communicating the merchant account provisioning data via a website (e.g., a website associated with acquirer system 110), an application (e.g., a mobile application associated with acquirer system 110), and/or a network (e.g., network 112). In some non-limiting embodiments or aspects, acquirer system 110 may receive merchant account provisioning data associated with provisioning the merchant account of the merchant from transaction service provider system 102, issuer system 104, user device 106 (e.g., user device 106 associated with a merchant, user device 106 associated with merchant system 108, and/or the like), and/or merchant system 108. For example, acquirer system 110 may receive merchant account provisioning data associated with provisioning the merchant account of the merchant from transaction service provider system 102, issuer system 104, user device 106, and/or merchant system 108 based on a merchant communicating the merchant account provisioning data via a website associated with transaction service provider system 102, issuer system 104, user device 106, and/or merchant system 108.

In some non-limiting embodiments or aspects, acquirer system 110 may perform an image capture technique (e.g., an optical character recognition (OCR) technique, and/or the like) on an electronic file (e.g., an electronic file associated with a document; an electronic image file associated with a document; an electronic file associated with a legal document of a merchant, such as an electronic file associated with a tax return document of a merchant; an electronic file associated with an image of a document, such as a pdf file of an image of a document; and/or the like) to determine the merchant account provisioning data associated with provisioning the merchant account of the merchant. For example, acquirer system 110 may perform an OCR technique on an electronic file to determine the merchant account provisioning data associated with provisioning the merchant account of the merchant.

As further shown in FIG. 3, at step 304, process 300 includes storing the merchant account provisioning data in a secure data structure. For example, acquirer system 110 may store the merchant account provisioning data in a secure data structure. In some non-limiting embodiments or aspects, acquirer system 110 may store the merchant account provisioning data in a secure data structure (e.g., an encrypted data structure, an encrypted database, a secure data structure that is secured based on government regulations, and/or the like) based on performing an image capture technique on an electronic file. For example, acquirer system 110 may perform an OCR technique on an electronic image file associated with a document to determine the merchant account provisioning data associated with provisioning the merchant account of the merchant. Acquirer system 110 may store the merchant account provisioning data in the secure data structure based on performing the OCR technique on the electronic image file associated with the document.

In some non-limiting embodiments or aspects, acquirer system 110 may store the merchant account provisioning data based on scanning an electronic image file and/or may store data associated with the electronic image file. For example, acquirer system 110 may store the merchant account provisioning data based on scanning an electronic image file and/or may store data associated with the electronic image file in the secure data structure based on performing an image capture technique on the electronic image file.

As further shown in FIG. 3, at step 306, process 300 includes validating the merchant account provisioning data for the merchant account of the merchant. For example, acquirer system 110 may validate (e.g., automatically validate) the merchant account provisioning data for the merchant account of the merchant. In some non-limiting embodiments or aspects, acquirer system 110 may validate the merchant account provisioning data for the merchant account of the merchant based on identification data associated with an identification of a merchant. For example, acquirer system 110 may validate the merchant account provisioning data for the merchant account of the merchant based on identification data associated with an identification of a plurality of merchants stored in a government database. In some non-limiting embodiments or aspects, acquirer system 110 may validate the merchant account provisioning data for the merchant account of the merchant based on validation rules. For example, acquirer system 110 may validate the merchant account provisioning data for the merchant account of the merchant based on a set of merchant account validation rules.

In some non-limiting embodiments or aspects, the set of merchant account validation rules may include a set of merchant account validation rules based on requirements associated with a government (e.g., government requirements, legal requirements set by a government, and/or the like). For example, the set of merchant account validation rules may include a set of merchant account validation rules based on government requirements of a country in which acquirer system 110 is located. Additionally or alternatively, the set of merchant account validation rules may include requirements associated with acquirer system 110. For example, the set of merchant account validation rules may include threshold merchant account requirements (e.g., threshold merchant account risk requirements, threshold requirements associated with a threshold account balance, threshold requirements associated with a period of time in which a merchant may have conducted business, and/or the like) associated with acquirer system 110.

As further shown in FIG. 3, at step 308, process 300 includes provisioning the merchant account of the merchant. For example, acquirer system 110 may provision (e.g., automatically provision) the merchant account of the merchant. In some non-limiting embodiments or aspects, acquirer system 110 may provision the merchant account of the merchant based on validating the merchant account provisioning data for the merchant account of the merchant according to validation rules.

In some non-limiting embodiments or aspects, acquirer system 110 may communicate a message to the merchant based on provisioning the merchant account of the merchant. For example, acquirer system 110 may communicate a message that includes a link to the merchant account to the merchant based on provisioning the merchant account of the merchant.

In some non-limiting embodiments or aspects, acquirer system 110 activates an application programming interface (API) (e.g., a domain specific API) that allows a payment transaction (e.g., a message associated with a payment transaction, an authorization message associated with a payment transaction, and/or the like) to be communicated from acquirer system 110 to a merchant (e.g., merchant system 108 associated with a merchant, a POS device of merchant system 108 associated with a merchant, and/or the like), and/or a transaction service provider (e.g., transaction service provider system 102 associated with a transaction service provider). For example, acquirer system 110 may activate the API that allows a payment transaction to be communicated from acquirer system 110 based on provisioning the merchant account for the merchant.

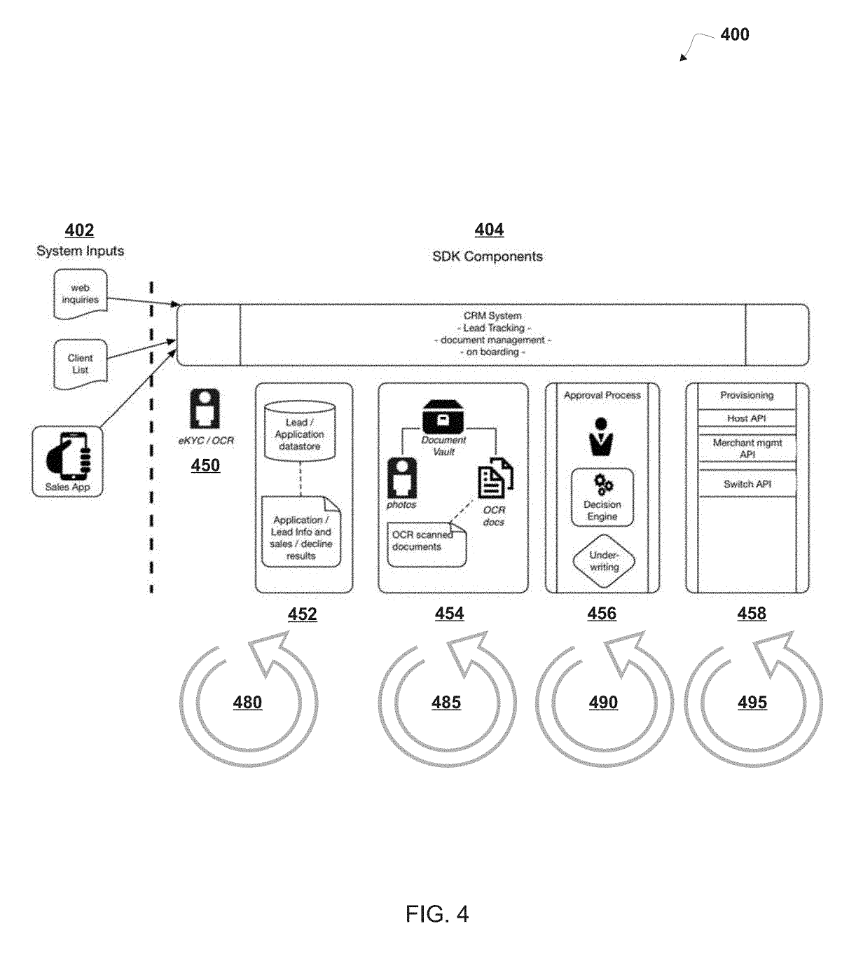

Referring now to FIG. 4, FIG. 4 is a diagram of an overview of a non-limiting embodiment or aspect of an implementation 400 relating to a process for automatically providing a merchant account for a merchant. As shown in FIG. 4, implementation 400 includes system inputs 402 and software development kit (SDK) components 404. In some non-limiting embodiments or aspects, system inputs 402 can be the same or similar to a merchant associated with the merchant account provisioning data communicating the merchant account provisioning data via a website (e.g., via web inquiries to a website associated with acquirer system 110), an application (e.g., a mobile application associated with acquirer system 110, such as a sales application, etc.) and/or a network (e.g., network 112) receiving one or more client lists from transaction service provider system 102, issuer system 104, user device 106 (e.g., user device 106 associated with a merchant, user device 106 associated with merchant system 108, and/or the like), and/or merchant system 108. In some non-limiting embodiments or aspects, SDK components 404 can be the same or similar to acquirer system 110. For example, SDK components 404 may include electronic know your customer (eKYC) and/or optical character recognition (OCR) system 450; lead application data store 452 including application data, lead information and sales data, decline results, and/or the like; secure document vault 454, approval system 456; provisioning system 458; or any combination thereof.

As shown by reference number 480 in FIG. 4, eKYC and/or OCR system 450 and/or lead application data store 452 may obtain and/or provide merchant account provisioning data associated with provisioning a merchant account of a merchant.

As shown by reference number 485 in FIG. 4, secure document vault 454 may store the merchant account provisioning data in a secure data structure (e.g., an encrypted data structure, an encrypted database, a secure data structure that is secured based on government regulations, etc.). In some non-limiting embodiments or aspects, secure document vault 454 may determine a type and/or a level of security for storing the merchant account provisioning data based on a government or country in which acquirer system 110 and/or the merchant for which the merchant account provisioning data is being stored is located. For example, a first government or country may have higher or stricter data security standards and/or encryptions standards than a second government or country depending on a location of acquirer system 110 and/or a location of the merchant. In some non-limiting embodiments or aspects, secure document vault 454 may store the merchant account provisioning data in a secure data structure according to the rules of a first government or country (e.g., a government or country associated with acquirer system 110, etc.) in association with a decryption or re-encryption scheme for translating the merchant account provisioning data to a different secure data structure according to the rules of a second government or country (e.g., a government or country associated with the merchant, etc.) without revealing the actual merchant account provisioning data to acquirer system 110, the merchant, and/or another party requesting and/or transferring the translated data.

As shown by reference number 490 in FIG. 4, approval system 456 validates the merchant account provisioning data for the merchant account of the merchant based on identification data associated with an identification of a plurality of merchants stored in a government database associated with the government or country according to which the merchant account provisioning data is stored in secure data document vault 454.

As shown by reference number 495 in FIG. 4, provisioning system 458 activates the API (e.g., a domain specific API) that allows a payment transaction (e.g., a message associated with a payment transaction, an authorization message associated with a payment transaction, and/or the like) to be communicated from acquirer system 110 to a merchant (e.g., merchant system 108 associated with a merchant, a POS device of merchant system 108 associated with a merchant, and/or the like), and/or a transaction service provider (e.g., transaction service provider system 102 associated with a transaction service provider) via the government or country according to which the merchant account provisioning data has been secured.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method for automatically providing a merchant account for a merchant, comprising:
receiving, by at least one processor, merchant account provisioning data associated with provisioning the merchant account of the merchant;
storing, by at least one processor, the merchant account provisioning data associated with provisioning the merchant account of the merchant in a secure data structure;
validating, by at least one processor, the merchant account provisioning data associated with provisioning the merchant account of the merchant based on a set of merchant account validation rules; and
provisioning, by at least one processor, the merchant account of the merchant based on validating the merchant account provisioning data.

2. The method of claim 1, further comprising:
performing an image capture technique on an electronic image file to determine the merchant account provisioning data associated with provisioning the merchant account of the merchant.

3. The method of claim 2, wherein storing the merchant account provisioning data comprises:
storing the merchant account provisioning data associated with provisioning the merchant account of the merchant in the secure data structure based on performing an image capture technique on an electronic image file.

4. The method of claim 1, wherein receiving the merchant account provisioning data comprises:
receiving the merchant account provisioning data associated with provisioning the merchant account of the merchant based on scanning an electronic image file of a document associated with the merchant.

5. The method of claim 1, wherein receiving the merchant account provisioning data comprises:
receiving the merchant account provisioning data associated with provisioning the merchant account of the merchant via a mobile application stored on a user device associated with the merchant.

6. The method of claim 1, wherein validating the merchant account provisioning data associated with provisioning the merchant account of the merchant based on a set of merchant account validation rules is associated with a country in which an acquirer system is locatied.

7. The method of claim 6, wherein the set of merchant account validation rules include at least one of the following: threshold merchant account risk requirements; threshold requirements associated with a threshold account balance; threshold requirements associated with a period of time in which a merchant may have conducted business; or any combination thereof.

8. A system for automatically providing a merchant account for a merchant, comprising:
one or more processors programmed and/or configured to:
receive merchant account provisioning data associated with provisioning the merchant account of the merchant;
store the merchant account provisioning data associated with provisioning the merchant account of the merchant in a secure data structure;
validate the merchant account provisioning data associated with provisioning the merchant account of the merchant based on a set of merchant account validation rules; and
provision the merchant account of the merchant based on validating the merchant account provisioning data.

9. The system of claim 8, wherein the one or more processors are further programmed and/or configured to:
perform an image capture technique on an electronic image file to determine the merchant account provisioning data associated with provisioning the merchant account of the merchant.

10. The system of claim 9, wherein the one or more processors store the merchant account provisioning data by:
storing the merchant account provisioning data associated with provisioning the merchant account of the merchant in the secure data structure based on performing an image capture technique on an electronic image file.

11. The system of claim 8, wherein the one or more processors receive the merchant account provisioning data by:
receiving the merchant account provisioning data associated with provisioning the merchant account of the merchant based on scanning an electronic image file of a document associated with the merchant.

12. The system of claim 8, wherein the one or more processors receive the merchant account provisioning data by:
receiving the merchant account provisioning data associated with provisioning the merchant account of the merchant via a mobile application stored on a user device associated with the merchant.

13. The system of claim 8, wherein the one or more processors validate the merchant account provisioning data associated with provisioning the merchant account of the merchant based on a set of merchant account validation rules associated with a country in which an acquirer system is located.

14. The system of claim 13, wherein the set of merchant account validation rules include at least one of the following: threshold merchant account risk requirements; threshold requirements associated with a threshold account balance; threshold requirements associated with a period of time in which a merchant may have conducted business; or any combination thereof.

15. A computer program product comprising at least one non-transitory computer-readable medium including program instructions that, when executed by at least one processor, cause the at least one processor to:
receive merchant account provisioning data associated with provisioning the merchant account of the merchant;
store the merchant account provisioning data associated with provisioning the merchant account of the merchant in a secure data structure;
validate the merchant account provisioning data associated with provisioning the merchant account of the merchant based on a set of merchant account validation rules; and
provision the merchant account of the merchant based on validating the merchant account provisioning data.

16. The computer program product of claim 15, wherein the one or more processors are further programmed and/or configured to:
perform an image capture technique on an electronic image file to determine the merchant account provisioning data associated with provisioning the merchant account of the merchant.

17. The computer program product of claim 16, wherein the one or more processors store the merchant account provisioning data by:
storing the merchant account provisioning data associated with provisioning the merchant account of the merchant in the secure data structure based on performing an image capture technique on an electronic image file.

18. The computer program product of claim 15, wherein the one or more processors receive the merchant account provisioning data by:
receiving the merchant account provisioning data associated with provisioning the merchant account of the merchant based on scanning an electronic image file of a document associated with the merchant.

19. The computer program product of claim 15, wherein the one or more processors receive the merchant account provisioning data by:
receiving the merchant account provisioning data associated with provisioning the merchant account of the merchant via a mobile application stored on a user device associated with the merchant.

20. The computer program product of claim 15, wherein the one or more processors validate the merchant account provisioning data associated with provisioning the merchant account of the merchant based on a set of merchant account validation rules associated with a country in which an acquirer system is located, and wherein the set of merchant account validation rules include at least one of the following: threshold merchant account risk requirements; threshold requirements associated with a threshold account balance; threshold requirements associated with a period of time in which a merchant may have conducted business; or any combination thereof.
